(19) United States
(12) Patent Application Publication
(10) Pub. No.: US 2008/0084139 A1
(43) Pub. Date: Apr. 10, 2008

(54) MOTOR HAVING ROTOR POSITION SENSOR

(75) Inventors: Scott M. Schroer, St. Charles, MO (US); Daniel E. Hilton, St. Louis, MO (US); Stephen J. Burton, Fenton, MO (US); Gary E. Horst, Manchester, MO (US); Gregory M. Levine, Olivette, MO (US)

Correspondence Address: SENNIGER POWERS LLP, ONE METROPOLITAN SQUARE, 16TH FLOOR, ST LOUIS, MO, 63102, US

(73) Assignee: EMERSON ELECTRIC CO., St. Louis, MO (US)

(21) Appl. No.: 11/538,479

(22) Filed: Oct. 4, 2006

(51) Int. Cl. H02K 7/00; H02K 11/00

(52) U.S. Cl. 310/67 R; 310/68 B

(57) ABSTRACT

A motor includes a rotor having at least one magnet. A stator includes multiple teeth and a sensor adjacent the magnet, or adjacent an air gap that is defined between the rotor and the stator. The majority of the teeth are identical in shape, or at least substantially identical. However, there is at least one distinct tooth (from among the teeth) that has a recess shaped to receive the sensor or a sensor housing. Thus, the distinct tooth has a different shape than the majority of the teeth to accommodate the sensor or sensor assembly.

### FIELD OF THE INVENTION

The invention relates to motors having rotor position sensors.

### BACKGROUND OF THE INVENTION

Conventional motors may include rotor position sensors, such as hall effect sensors, on the stator and adjacent a magnet of the rotor. The sensor should be disposed so that it does not affect performance of the motor. Also, in applications where motor size is important, the sensor should not increase the overall size of the motor. In older conventional motors, this was possible by placing the sensor (or sensors) between adjacent teeth of the stator. In these older motors, the teeth were sufficiently far apart for such configuration to work effectively without sacrificing performance.

However, new, higher performance motors include stators having wider teeth, e.g., T-shaped teeth, where the gap between teeth is reduced. Such teeth are shown in co-assigned U.S. Pat. No. 6,946,760, which is incorporated herein by reference. This tooth shape increases the performance and efficiency of the motor for its relative size, but it is difficult to place the sensor between the teeth without negatively affecting motor performance. Up to now, the sensor has been placed above or below the stator teeth, rather than in the gaps between teeth, to arecess negatively affecting performance. This placement usually has the effect of increasing the height (or size) of the magnet so that it is in registration with the sensor, and of increasing the overall size and weight of the motor. Accordingly, a stator and sensor configuration that does not degrade the performance of the motor and reduces the size and weight of the motor is needed.

### SUMMARY OF THE INVENTION

In some embodiments of the invention, a motor includes a rotor having at least one magnet. A stator includes multiple teeth and a sensor assembly adjacent the magnet, or adjacent an air gap that is defined between the rotor and the stator. The majority of the teeth are identical in shape, or at least substantially identical. However, there is at least one distinct tooth (from among the teeth) that has a recess shaped to receive at least a portion of the sensor assembly. Thus, the distinct tooth has a different shape than the majority of the teeth.

In other embodiments, the motor includes a sensor housing on the stator. The housing has at least two hall-effect sensors, and the sensors are disposed adjacent the air gap. The sensors can sense the magnet in the rotor positioned across the air gap from the sensors. Again, the majority of the teeth have a first shape, but at least three distinct teeth have a recess shaped to receive at least a portion of the sensor housing.

Various refinements exist of the features noted in relation to the above-mentioned aspects of the present invention. Further features may also be incorporated in the above-mentioned aspects of the present invention as well. These refinements and additional features may exist individually or in any combination. For instance, various features discussed below in relation to any of the illustrated embodiments of the present invention may be incorporated into any of the above-described aspects of the present invention, alone or in any combination.

### BRIEF DESCRIPTION OF THE DRAWINGS

FIG. 1 is a perspective view of a motor of one embodiment, portions being omitted for clarity.

FIG. 2 is an exploded view of the motor of FIG. 1.

FIG. 3 is a perspective of the stator shown in FIG. 2.

FIG. 3A is a perspective of a sensor assembly.

FIG. 4 is a perspective of the stator of FIG. 3 but with portions omitted for clarity.

FIG. 5 is a perspective of a stator/sensor configuration of another embodiment.

FIG. 6 is a perspective like FIG. 5 but with the sensor omitted.

FIG. 7 is a perspective of a stator/sensor configuration of still another embodiment.

FIG. 8 is a perspective like FIG. 7 but with the sensor omitted.

### DETAILED DESCRIPTION OF THE DRAWINGS

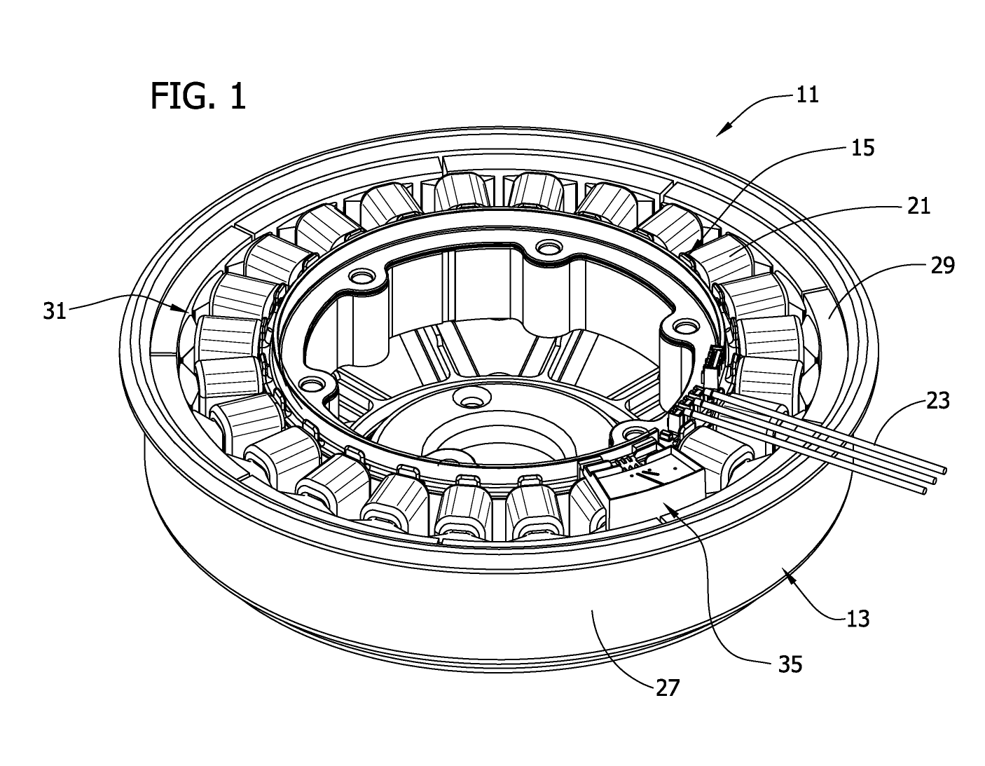

Referring to FIGS. 1-3, a motor of one embodiment of the invention is generally designated 11. The motor generally comprises a rotor generally designated 13 and a stator generally designated 15. The stator includes a center hub 17 and a plurality of teeth 19 extending outward from the center hub. Windings 21 are wound around each tooth 19. The motor may also include a controller and wires 23 for power connection and the like. Other details of construction need not be shown or described herein but will be understood by those of ordinary skill in the art. Also, the motor 11 of this embodiment is an outer rotor brushless permanent magnet motor, but many other types of motors, including for example, inner rotor motors, are contemplated within the scope of the invention.

The rotor 13 includes a rotor can 27 having magnets 29 mounted on an inwardly facing surface. There is an air gap between the magnets and outward faces of the stator teeth, the air gap generally designated 31 in FIG. 1. Note that a variety of other magnet configurations are contemplated.

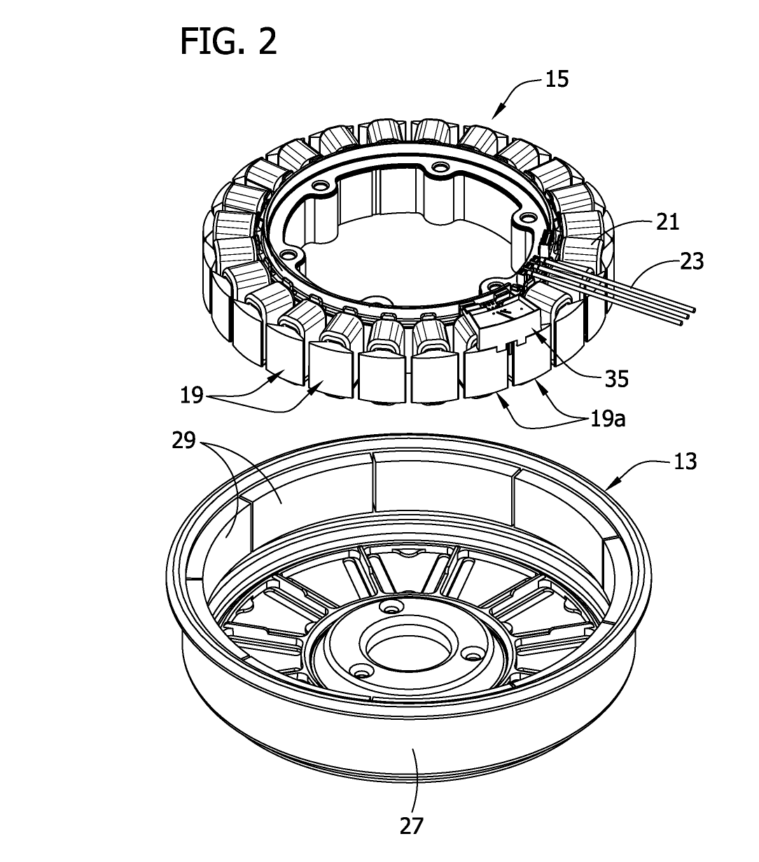

A sensor assembly of this embodiment is designated 35 and is generally disposed atop the windings 21 and the teeth 19, as viewed in FIGS. 1 and 2. As will be further described below, the sensor assembly 35 includes a housing 37 having at least one sensor 39 therein adjacent the magnets 29 for sensing the magnets of the rotor. The housing 37 covers and protects the sensor 39, among other functions.

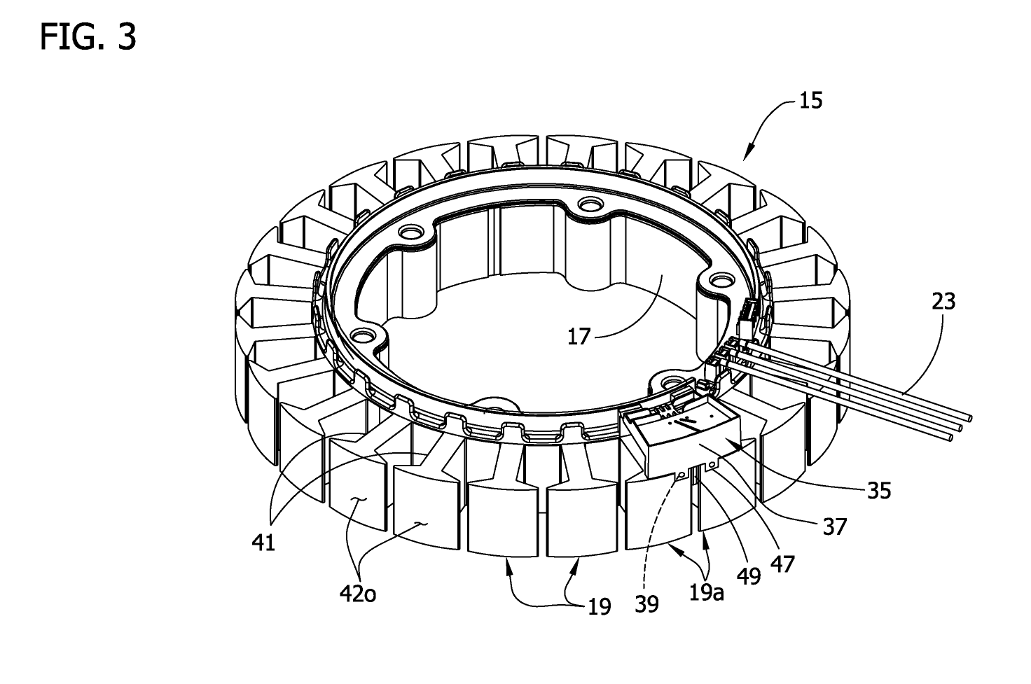

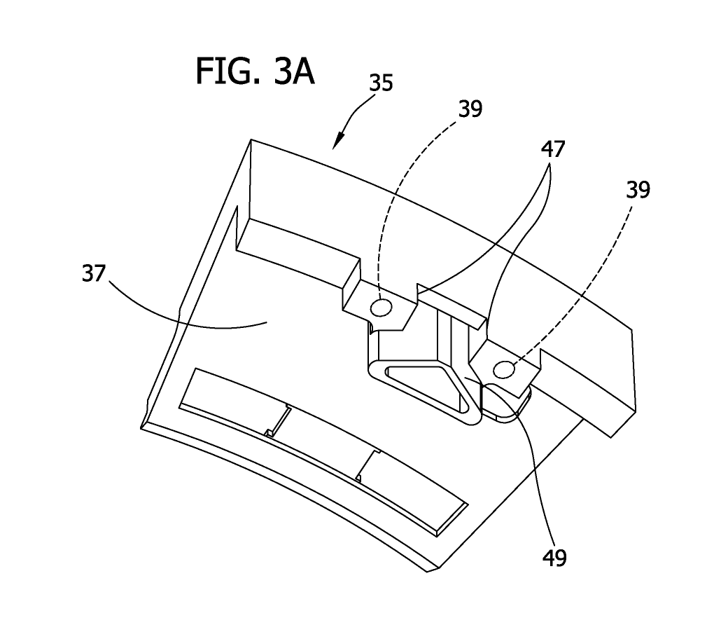

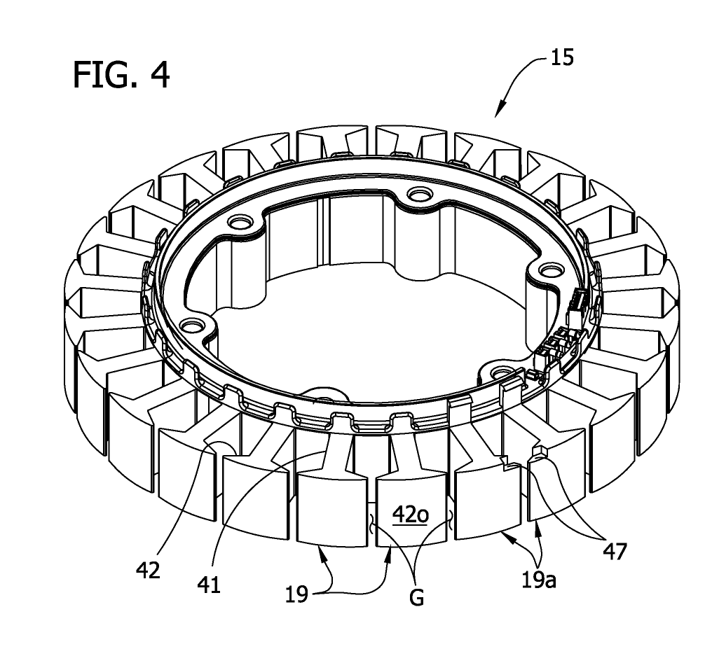

As best shown in FIGS. 3-4, each tooth 19 has a T-shape when viewed in cross-section taken transverse to a longitudinal axis of the stator 15. A first or long section 41 of the T-shape extends radially outward from the center hub 17 and a second or crossing section 42 extends circumferentially and generally symmetrically from the long section. An outward face 42o of the crossing section of each tooth is curved or “crowned” to generally conform to, or be complementary to, the shape of the magnets.

As noted above, the T-shape of the teeth 19 of this embodiment results in a small gap G between the crossing sections 42 of adjacent teeth, the gap between the teeth being smaller than the width of the sensor assembly 35 so that the sensor assembly cannot fit between the majority of the teeth. Alternatively, the gap may be smaller or roughly equal to the size of the sensor itself. Note that the gap G is different from the air gap 31 discussed above.

In this embodiment, a small notch or recess 45 is shaped into two adjacent “distinct” teeth 19a so that the voids are spaced apart a predetermined distance. These two teeth have a shape that is different or distinct from the other teeth 19 of the stator 15. The two teeth are optionally made to be “mirror image”, or symmetric about the gap G, but they need not be.

The housing 37 of the sensor assembly 35 is generally received in the recesses 45. As shown in FIGS. 3 and 3A, the housing has two tabs 47 that engage edges of the recess, and each tab has one of the sensors 39. The sensor 39 is thus disposed adjacent the magnets 29, or across the air gap 31 from the magnets so that the sensor can sense each magnet as the magnet passes the sensor. In this case, each sensor 39 is mounted inside the tab 47, as by molding the sensor into the housing 37 during molding of the housing. However, the sensor may be mounted in many other ways.

An alignment leg 49 (broadly, alignment feature) extends downward from the main portion of the housing 37 between the tabs 47. The alignment leg 49 is sized and shaped to engage the inward surfaces of the crossing sections 42 of the teeth 19a. The alignment leg 49 helps ensure that the sensor assembly 35, especially the sensors 39 are properly disposed relative to the teeth 19a and to the rotor 13.

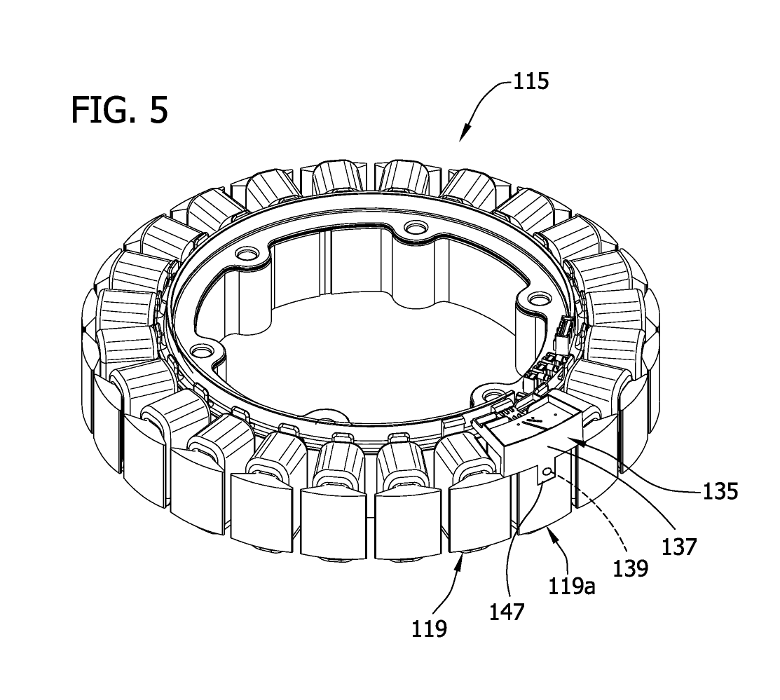

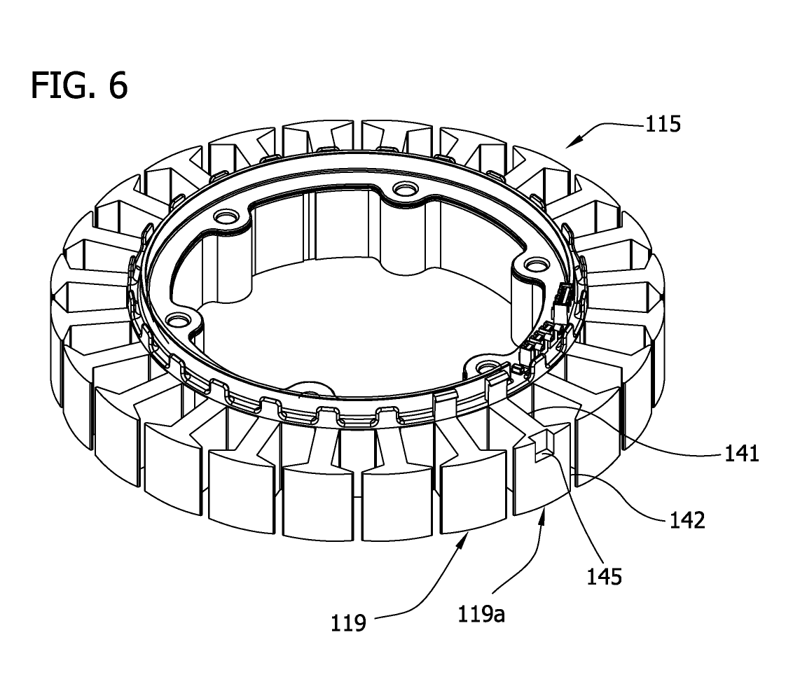

In another embodiment shown in FIGS. 5-6, a stator 115 includes only one tooth 119a having a recess 145. (In other words, only one tooth is “distinct” from the rest of the teeth.) The recess is formed generally centrally in the crowned section 142 of the tooth 119a so that the sensor 139 of sensor assembly 135 is disposed generally at an end of the long section 141 of the distinct tooth. Thus, the long section 141 extends inward from the sensor 139 of this embodiment. Note no alignment feature is shown, but may be added. Other features of the motor of this embodiment may be substantially similar to that of the first embodiment.

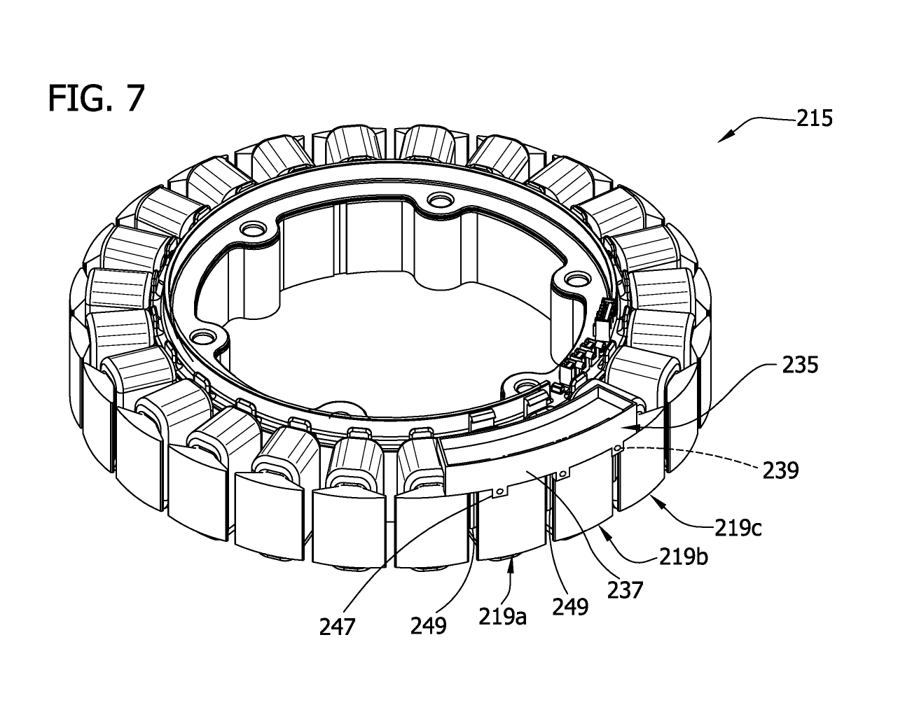

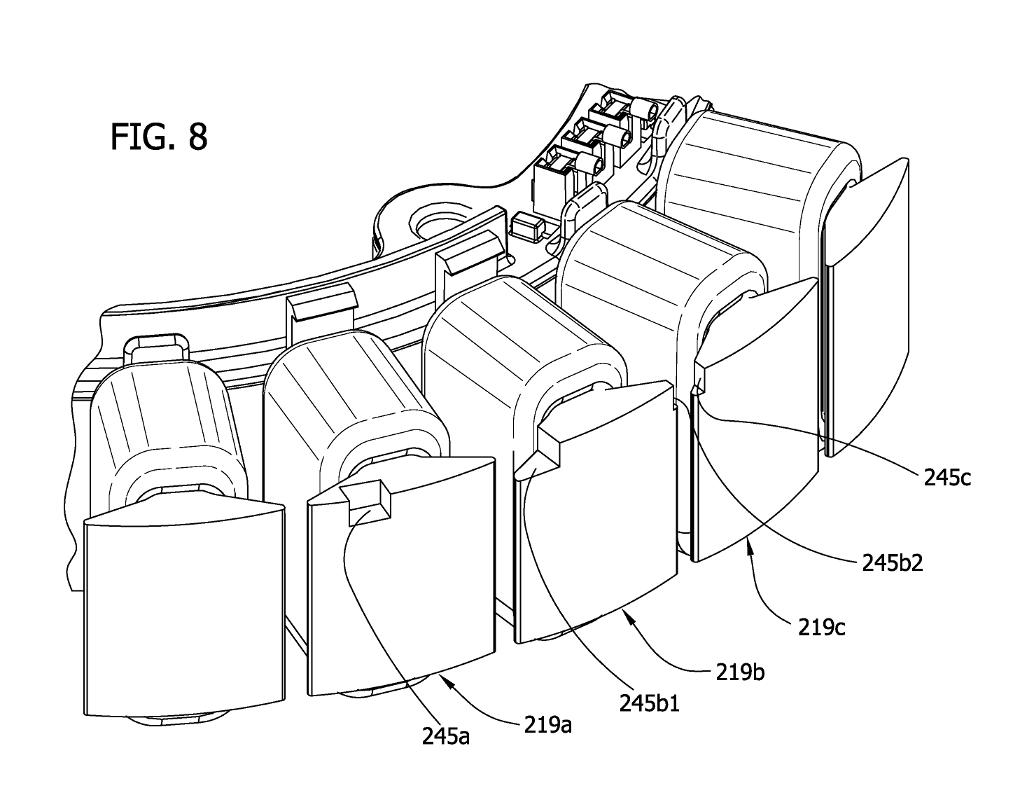

In still another embodiment shown in FIGS. 7-8, a stator 215 has three teeth 219a-219c, each including at least one recess. A first distinct tooth 219a includes a recess 245a somewhat offset from its center at its top edge. A second distinct tooth 219b adjacent the first has one recess 245b1 along its top edge and extending to the edge facing the first tooth, and a smaller recess 245b2 along the top edge that faces a third distinct tooth 219c. The third distinct tooth has a small recess 245c along its top edge that faces the second tooth. As shown in FIG. 7, the sensor assembly 235 has a housing 237 that extends over the three teeth 219a-c. The housing has three tabs 247 that engage the respective recesses, and has three sensors 239 that are disposed in respective gaps G, similar to that of the first embodiment. Thus, the recesses 245a-c and sensors 239 are equally spaced apart a predetermined distance. Note that the spacing may depend, for example, on the number of poles and the number of sensors used, among other possible factors. Also, three alignment legs 249 are included and function as described above.

The recess in each “distinct” tooth may be formed in a variety of ways. For example, the recess may be formed by machining of the tooth. Alternatively, the laminations that make up the stator may be formed with the recess therein, as during stamping of the laminations.

The sensors of the various embodiments may be of a variety of types. For example, the sensor may be a hall-effect sensor, and may be of the type that senses speed, position or both for the rotor. It is contemplated that the housings of the various embodiments include any number of sensors, and further, it is contemplated that the housing be omitted altogether. As will be understood by those of ordinary skill, the sensor assembly may include additional components within the scope of the invention. Also, the sensor and/or sensor assembly may be described as being adjacent a magnet, even though the sensor is only momentarily adjacent a particular magnet as the rotor rotates during normal operation of the motor.

When introducing elements of various aspects of the present invention or embodiments thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “top” and “bottom”, “front” and “rear”, “above” and “below” and variations of these and other terms of orientation is made for convenience, but does not require any particular orientation of the components.

As various changes could be made in the above constructions, methods and products without departing from the scope of the invention, it is intended that all matter contained in the above description or shown in the accompanying drawings shall be interpreted as illustrative and not in a limiting sense. Further, all dimensional information set forth herein is exemplary and is not intended to limit the scope of the invention.

What is claimed is:

1. A motor comprising a rotor including at least one magnet, a stator including a plurality of teeth and a sensor assembly for sensing the magnet, a distinct tooth of said plurality having a recess shaped to receive at least a portion of the sensor assembly, the majority of said teeth having a substantially identical shape and not including the recess so that the distinct tooth has a different shape than the majority of the teeth.

2. The motor as set forth in claim 1 wherein each tooth has a T-shape in a cross-section taken transverse to the axis of the stator, a first section of the T-shape extending radially and a second section extending circumferentially.

3. The motor as set forth in claim 2 wherein the distinct tooth has said T-shape and the recess is formed in the second section.

4. The motor as set forth in claim 3 wherein the sensor assembly is disposed on the second section so the first section extends radially inward from the sensor

5. The motor as set forth in claim 4 wherein a gap is formed between the second sections of respective adjacent teeth, the gap being smaller in width than the sensor assembly.

6. The motor as set forth in claim 1 wherein each tooth has a T-shape with a first section extending radially and a second section extending circumferentially, the distinct tooth likewise having a T-shape and the recess being formed in the second section such that the first section extends radially from the recess.

7. The motor as set forth in claim 1 wherein the sensor assembly includes two or more of said sensors.

8. The motor as set forth in claim 1 wherein a gap between teeth of the stator is smaller in width than the sensor assembly, but a portion of the assembly is located in the gap.

9. The motor as set forth in claim 1 wherein at least a portion of the rotor is located radially outwardly from the stator.

10. The motor as set forth in claim 1 wherein the sensor assembly includes a hall-effect sensor.

11. The motor as set forth in claim 1 wherein the sensor assembly includes a sensor adapted for sensing position of the rotor.

12. The motor as set forth in claim 1 wherein the sensor assembly is adapted for sensing speed of the rotor.

13. The motor as set forth in claim 1 wherein the sensor assembly includes a housing receiving at least one sensor, a portion of the housing being received in the recess.

14. A motor comprising a rotor, a stator including a plurality of teeth, an air gap being defined between the rotor and stator, and a sensor assembly including at least two sensors on the stator disposed adjacent the air gap, wherein the majority of the teeth have a first shape, at least two teeth having a distinct shape that is different than the first shape, the distinct shape including a recess shaped to receive at least a portion of the sensor assembly.

15. The motor as set forth in claim 14 wherein each tooth has a T-shape in a cross-section taken transverse to the axis of the stator, a first section of the T-shape extending radially and a second section extending circumferentially.

16. The motor as set forth in claim 15 wherein the distinct teeth have said T-shape and the recess is formed in the second section.

17. The motor as set forth in claim 16 wherein the sensor assembly includes a housing for the sensors, at least a portion of the housing being received in the recess.

18. A motor comprising a rotor including at least one magnet, a stator including a plurality of teeth, an air gap defined between the stator and rotor, a sensor housing on the stator having at least two hall-effect sensors therein and disposed adjacent the air gap so that the sensors may sense the rotor disposed across the air gap from the sensors, the majority of the teeth having a first shape and a gap between at least a portion of adjacent teeth that is smaller than the sensor housing, at least three teeth having a distinct shape that is different than the first shape, the distinct shape including at least one recess shaped to receive at least a portion of the sensor housing.

19. The motor as set forth in claim 18 wherein each tooth has a T-shape in a cross-section taken transverse to the axis of the stator, a first section of the T-shape extending radially and a second section extending circumferentially.

20. The motor as set forth in claim 19 wherein the distinct teeth have said T-shape and the at least one recess is formed in the second section.
